(19) United States
(12) Patent Application Publication
(10) Pub. No.: US 2009/0195053 A1
(43) Pub. Date: Aug. 6, 2009

(54) RIM OR WHEEL ADD-ON PART FOR A MOTOR VEHICLE WHEEL HAVING CLOSABLE OPENINGS

(75) Inventors: Nicolas KRUSE, Mainz (DE); David IMAI, Frankfurt am Main (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/365,790

(22) Filed: Feb. 4, 2009

(30) Foreign Application Priority Data
Feb. 6, 2008 (DE) 102008007690.2

(51) Int. Cl. B60B 19/10

(52) U.S. Cl. 301/6.4

(57) ABSTRACT

A part (e.g., a rim) of a wheel of a motor vehicle is provided that has closable ventilation openings which may have flow through them in the open state in the axial direction to the wheel axle, an actuator being provided which is implemented to open and close the ventilation openings.

### CROSS-REFERENCE TO RELATED APPLICATION

This application claims priority to German Patent Application No. 102008007690.2, filed Feb. 6, 2008, which is incorporated herein by reference in its entirety.

### TECHNICAL FIELD

The present invention relates to a rim and/or an add-on part provided for a motor vehicle wheel as well as an associated wheel for a motor vehicle, openings being provided in the area of the rim which allow ventilation of functional parts situated in the area of the rim, such as a motor vehicle brake unit.

### BACKGROUND

Ventilation units for brakes are generally known. For example, DE 38 34 119 A1 describes brake cooling flaps which are situated in the vehicle body, for example, in the front spoiler of a motor vehicle, and are closed using suitable drive means during a normal travel state of the vehicle, but are automatically opened upon brake cooling demand, the travel wind causing an air flow through the brake cooling flaps and through the air guiding pathways which flows to the brake system and cools it.

Furthermore, a cooling unit for a brake system of a motor vehicle is known from DE 38 40 321 A1, at least one fan wheel revolving around an axis being provided for generating a cool-ant air flow for brake elements of the brake system. This fan wheel is connected to a brake element revolving with the vehicle wheel via a freewheel to drive it. This fan wheel is carried along upon an acceleration of the vehicle by the rotating vehicle wheel, for example. In contrast, if the rotational movement of the vehicle wheel slows down, the fan wheel may freely revolve further, so that in particular even after an actuation of the brake system, a coolant air flow and an active cooling of the brake elements may be achieved.

Furthermore, so-called “spinner wheels” are known in the prior art. These are rotationally mounted “ornamental discs”, which rotate in relation to the actual wheel. Such a configuration results, similarly to DE 38 40 321 A1, in an optical effect when a vehicle is stationary and its wheels appear to rotate further while standing. The free rotation of such “spinner wheels” or a fan wheel having a freewheel conceals a significant potential danger, however, since because of the mass of such rotatably mounted elements, which is not negligible, and possible off-center and/or unbalanced mounting, high safety-relevant requirements are placed on the fastening. Such rotating freewheeling systems are thus permissible only in a limited way in street traffic.

In view of the foregoing, at least one object is to optimize the aerodynamics of the motor vehicle and optionally provide a cooling unit for functional parts situated in the area of the motor vehicle wheels, such as brake, actuating, or drive units, with insignificant or no changes to the vehicle body of the motor vehicle. In addition, the achievable aerodynamic improvement is to be able to be retrofitted independently of the motor vehicle type at any time, universally, and easily. Furthermore, other objects, desirable features and characteristics will become apparent from the subsequent summary and detailed description and the appended claims, taken in conjunction with the accompanying drawings and this background.

### SUMMARY

The at least one object, other objects, desirable features and characteristics is achieved using a rim or a wheel add-on part according to an embodiment and a motor vehicle wheel according to an embodiment.

More specifically, a rim or a wheel add-on part for a motor vehicle wheel is provided according to an embodiment that has closable openings, in particular ventilation openings. These openings may have a coolant flow through them, in particular a coolant air flow, in the open state in the axial direction to the wheel axle. In addition, an actuator is provided, which is implemented to open and close the openings. In this way, in driving situations in which no additional cooling of the motor vehicle brakes is necessary, such ventilation openings may advantageously be closed. In this closed state, the rim or the wheel has an essentially completely closed surface between wheel hub and the tire fastened to the rim. Such a closed surface of the rim, which preferably terminates flush with the tire, noticeably decreases the air resistance of the vehicle.

The flow resistance of the vehicle may thus be decreased by up to about 5% in relation to a rim designed as structured and/or open. The ventilation resistance of the wheel rim when the wheel rotates is also decreased by its closed implementation.

If the driving situation or, for example, heating of the brake unit requires corresponding cooling, the ventilation openings of the rim are opened as a function of the operating state of the brake and/or the particular prevailing driving situation, so that a coolant air flow flows through the rim only if needed and thus results in improved cooling of the brake unit situated in the area of the rim.

Furthermore, the rim according to an embodiment is to be viewed as advantageous not only in regard to improved cooling properties, but rather also in regard to an aesthetic appearance of the wheel(s). The external appearance of a rim thus normally contributes significantly to the purchasing decision. Structured, non-smooth rim geometries are particularly desired by the buyer. However, if the vehicle moves at high velocity, because of the rotation of the wheel, the rim contour and its external appearance may no longer be precisely perceived in any case.

A further embodiment begins here, in that it changes ventilation openings and thus the external appearance of the rim as a function of velocity, for example, so that when stationary an external rim contour corresponding to the aesthetic requirements is recognizable, and at higher velocity an aerodynamically favorable flat and/or smooth surface of the rim is provided.

According to a first refinement of the embodiment, the actuator assigned to the rim or situated directly on the rim is implemented to open and/or close the openings automatically as a function of an acting acceleration or deceleration of the vehicle and/or the motor vehicle wheel. An acceleration-dependent control of this type may be performed, for example, by exploiting the mass inertia of elements possibly covering the ventilation openings, without an active control being necessary for this purpose.

Furthermore, according to a refinement, the ventilation openings of the rim are opened or closed as a function of a temperature prevailing in the area of the rim. A temperature-dependent control of this type may be performed using temperature-sensitive elements, for example, such as a bimetal spring or similar elements which deform under thermal action. These elements may be in thermal contact with the brake, the wheel hub, or the rim, for example, and thus cause reversible opening or closing of the ventilation openings, also automatically, by their temperature-dependent deformation.

Furthermore, according to a refinement, the ventilation openings are opened or closed as a function of a rotational velocity of the rim. In this case, but also in the other embodiments, the ventilation openings may particularly be opened or closed gradually, so that the ventilation openings are only partially opened or closed as a function of parameters such as acceleration, velocity, or temperature.

According to a further advantageous embodiment, the rim has a main body provided with ventilation openings. However, except for the openings incorporated into the rim, it has an external profile which is essentially closed axially to the outside. Furthermore, closure elements are assigned to the individual ventilation openings, which may be situated axially, spaced apart from the rim, but also directly on the rim and/or its main body.

The openings may thus be incorporated in the rim main body. Alternatively or additionally, however, a separate wheel add-on part may be combined with a typical rim, for example, a rim made open throughout. At least a part, but preferably all of the closable openings are then provided on the wheel add-on part, which may be situated on commercially available rims and motor vehicle wheels. In this way, rims which are made as at least regionally open in the axial direction may be provided with a wheel add-on part according to an embodiment and accordingly retrofitted. The wheel add-on part has a main body provided with openings and at least one closure body which is situated so it is pivotable in relation to this main body.

According to a refinement of the embodiment, the closure elements assigned to the individual ventilation openings of the rim are mechanically coupled among one another. The closure elements are mounted so they are pivotable on the rim main body around an axis which extends parallel to the wheel axle and/or to the wheel hub. In this way, a pivotable configuration of the closure elements on the rim is provided, the pivot movement of the closure elements occurring in a plane transverse to the wheel axle.

Alternatively, it is conceivable that the closure elements are implemented like flaps and are mounted as pivotable around a rotational axis extending in the radial direction in relation to the wheel axle. The pivot angle may be up to about 90° in such a design.

According to an advantageous refinement, the individual closure elements are situated on or at a closure body. This closure body is mounted so it is pivotable per se around the circumference in relation to the rim main body. It may be mounted directly on the rim main body. In particular, the individual closure elements are connected to one another in one piece and form the closure body in this way. The closure body may thus be viewed as a single element, which has closure areas and opening areas comparable to the implementation of the rim.

If opening areas of the closure body functioning as ventilation openings are configured overlapping with assigned ventilation openings of the rim main body, for example, the ventilation openings of the rim may have coolant air flow through them. In contrast, if the closure bodies are rotated around the circumference in relation to the rim body, so that an overlapping configuration of corresponding openings in the closure body and in the rim main body is no longer provided, the ventilation openings are closed. The rim then has an essentially homogeneous closed contour to the outside.

According to a refinement, the closure body is mounted so it is pivotable in relation to the rim main body. The pivot range around the circumference is at least approximately 0 to 60°. The closure body is otherwise connected quasi-rigidly to the rim main body. In particular, in contrast to the previously known “spinner wheels”, there is no free-wheel between the closure body and the rim main body.

According to a refinement, the closure body has a disc-like geometry and individual passages between the closure elements, which may be situated like spokes, for example. These passages come to rest at least regionally overlapping with the ventilation openings of the rim main body in the open position of the ventilation openings.

The geometry of the ventilation openings of the closure body and that of the rim main body are corresponding with one another, if not even identical. For example, they may be implemented as round, elliptical, triangular, square, or like a circular segment. If openings like circular segments are implemented, the closure body and/or the rim main body has a geometry appearing like spokes.

Furthermore, the closure body is situated offset axially to the outside or axially to the inside in relation to the rim main body. The closure body is thus located on one side of the rim main body. It may be coupled directly to the rim main body, or alternatively also suspended on the wheel hub or the wheel axle.

According to a further advantageous embodiment, the rim or the wheel add-on part has individual planar segments on its axial exterior side, which are mounted so they are pivotable around axes running in the radial direction. For example, a configuration like a fan or like turbine blades is provided for this purpose, the individual planar segments coming to rest in the plane transverse to the wheel axle depending on the existing external requirements and thus forming an externally closed surface or the planar segments being pivoted in such a way that their surface normals run diagonally or even perpendicular to the wheel axle, so that openings in the area of the rim are exposed.

According to another independent embodiment, a motor vehicle wheel is provided with a rim as previously and subsequently described.

### BRIEF DESCRIPTION OF THE DRAWINGS

The present invention will hereinafter be described in conjunction with the following drawing figures, wherein like numerals denote like elements, and

FIG. 1 shows a schematic illustration of a motor vehicle in longitudinal section having open ventilation openings;

FIG. 2 shows an illustration according to FIG. 1 having closed ventilation openings;

FIG. 3 shows a schematic illustration of a motor vehicle rim according to an embodiment in a top view;

FIG. 4 shows a closure body to be situated on the rim in a top view;

FIG. 5 shows the rim according to FIG. 3 having closure body according to FIG. 4 situated thereon having open ventilation openings;

FIG. 6 shows the motor vehicle wheel according to FIG. 5 having rotated closure body and closed ventilation openings;

FIG. 7 shows an alternative embodiment having fan- or wing-like closure elements in a closed configuration; and

FIG. 8 shows the embodiment according to FIG. 7 in an open configuration.

### DETAILED DESCRIPTION

The following detailed description is merely exemplary in nature and is not intended to limit application and uses. Furthermore, there is no intention to be bound by any theory presented in the preceding summary and background or the following detailed description.

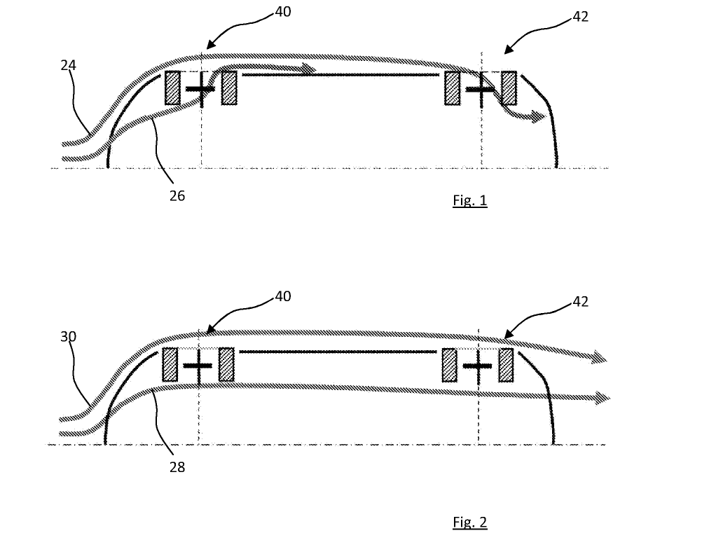

FIG. 1 shows one side of a motor vehicle in a sectional illustration from below. The two left wheels of the motor vehicle, namely front wheel 40 and rear wheel 42, are shown. Furthermore, two air flows 24 and 26 are shown, which contribute to the cooling of a brake unit situated in the area of the wheels. FIG. 1 shows the state of the rim according to an embodiment having open ventilation openings. The air flow 24 flowing past the front wheel 40 flows externally through the rear wheel 42 at least regionally in the axial direction from the outside to the inside, while the air flow 26 flows through the front wheel in the axial direction from the inside to the outside.

The alternative configuration of the rim having closed ventilation openings is indicated in FIG. 2. In this configuration, the rims and/or the wheels 40, 42 are nearly impenetrable to an air flow flowing in the axial direction. The two air flows 30, 28 either flow completely past the exterior side of the motor vehicle or past the interior of the wheels 40, 42, without flowing through them in the axial direction.

While FIG. 2 shows a configuration as is provided for minimizing the air resistance, in particular at high velocities, FIG. 1 shows a configuration which is typically to be assumed in braking situations, in which the brakes situated in the area of the wheels 40, 42 have a need for coolant air supply.

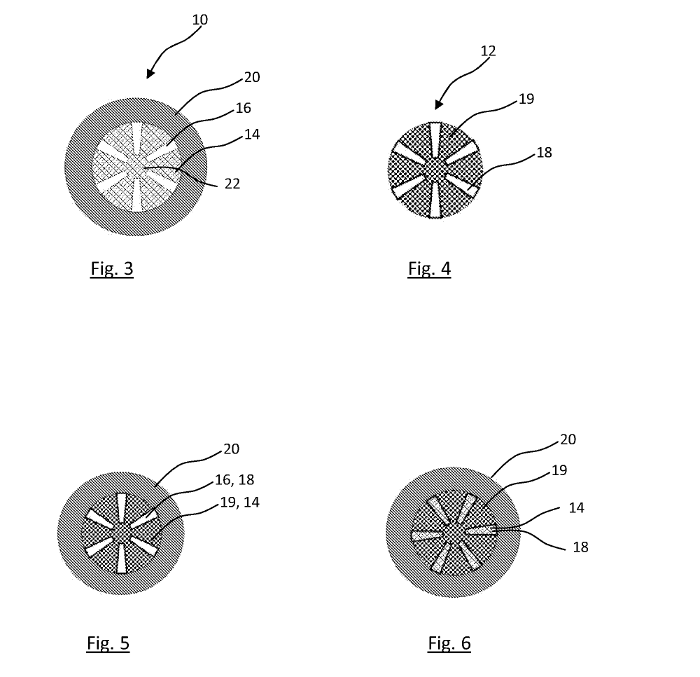

The vehicle rim 10 according to FIGS. 3, 5, and 6 is provided for receiving an exemplary closure body 12 shown in FIG. 4. In the illustration of FIG. 6, this closure body extends over the ventilation openings 16 of the rim main body 14, so that an externally closed rim profile results. In this configuration, the rim 10 is impermeable to flow in the axial direction, as indicated in FIG. 2. Correspondingly, the exemplary air flows 28, 30 shown in FIG. 2 flow along the interior or exterior of the rim without axially penetrating it.

In this configuration according to FIG. 2, the vehicle rim and/or the entire vehicle wheel has a significantly decreased flow resistance than a configuration as shown in FIG. 1.

Furthermore, the tire profile 20 lying radially on the outside terminates flush with its external contour in the transition area to the rim or to the rim main body 14. In this configuration according to FIG. 6, which corresponds to FIG. 2, the actual rim main body 14 is nearly completely covered by the closure body 12. Individual ventilation openings 18 or 16, which are implemented as truncated cones or tetrahedrons in the example shown, are provided both on the closure body 12 and also on the rim main body 14. The closure body 12 has individual closure areas or elements 19 between the ventilation openings according to FIG. 4. The rim main body comes to rest behind the ventilation openings 18 in the configuration of FIG. 6.

Although the illustration of FIG. 6 shows a specific structure of the rim, the rim main body 14 and the closure body press directly against one another. Due to the disc-like de-sign of the closure body 12, which is comparatively thin in the axial direction, the rim main body 14 and the closure body 12 form an essentially flatly formed surface having a correspondingly low and advantageous flow resistance.

The wheel hub 22, which may be used as a suspension for both the rim main body 14 and also the closure body 12, is indicated as an example centrally in the rim 10 in FIG. 3.

In the configuration according to FIG. 5, the closure body is located in a slightly pivoted or rotated position in relation to its position in FIG. 6, so that the ventilation openings 18, 16 incorporated in the closure body 12 and in the rim main body 14 come to rest overlapping at least regionally, in the present example even completely. In this way, an air flow flowing through the rim in the axial direction is made possible through the open area, which is capable of better cooling of the brake unit provided in the area of the rim. The configuration according to FIG. 5 allows a flow course as indicated in FIG. 1.

The relative movement between the closure body 12 and the rim main body 14 may be performed actively by provided actuating motors and an electronic control unit, which is supplied with sensor signals. Alternatively or additionally thereto, it is also possible that the adjustment of the closure body 12 in relation to the rim main body 14 is performed automatically, for example, by exploiting the mass inertia of the closure body or by providing temperature-sensitive elements and a mechanical coupling connected thereto.

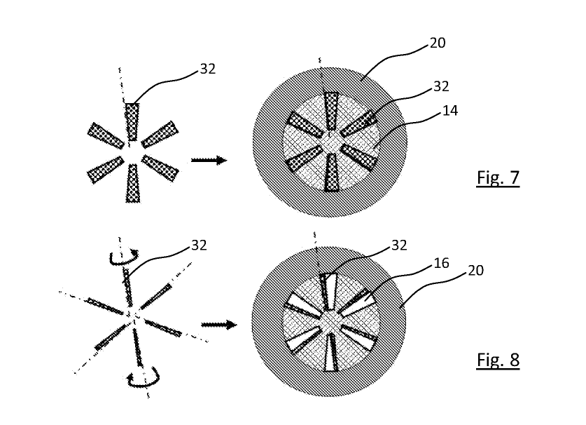

An alternative embodiment is shown in FIGS. 7 and 8. Individual closure elements 32 are situated on the main body of the rim or an add-on component to be attached separately to the wheel. As may be seen from the comparison of the two figures shown on the left in FIG. 7 and FIG. 8, these individual closure elements 32 are implemented as pivotable in relation to their longitudinal axis. Their longitudinal axes run in the axial direction in relation to the axle of the wheel and the individual closure elements are implemented like flaps.

In the pivoted configuration shown in FIG. 8, they expose the opening areas 16 of the main body of the rim, so that the openings 16 may have coolant air flow through them in the axial direction.

The individual closure elements 32 are also mechanically coupled among one another in this embodiment. All closure elements 32 may also be fastened to a closure body (not explicitly shown in the figures), which is mounted so it is pivotable in relation to the wheel hub or the main body of the rim.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A part for a wheel of a motor vehicle, comprising:
a plurality of apertures configured for flow in an axial direction to an axle of the wheel when the plurality of apertures are in an open state; and
an actuator configured to adjust the open state of the plurality of apertures.

2. The part according to claim 1, wherein the actuator is configured adjust the plurality of apertures from the open state to at least partially closed state in response to at least one of acceleration and deceleration of the motor vehicle.

3. The part according to claim 1, wherein the actuator is configured adjust the plurality of apertures from the open state to at least partially closed state in response to a temperature function.

4. The part according to claim 1, wherein the actuator is configured adjust the plurality of apertures from the open state to at least partially closed state in response to a rotational velocity function.

5. The part according to claim 1, further comprising a main body housing the plurality of apertures; and
a plurality of closure elements are assigned to the plurality of apertures.

6. The part according to claim 5, wherein the plurality of closure elements are mechanically coupled among one another.

7. The part according to claims 5, wherein the plurality of closure elements are pivotably mounted in relation to the main body around a pivot axis running substantially parallel to the axle.

8. The part according to claims 5, wherein the plurality of closure elements are associated with a closure body that is pivotably mounted around a circumference in relation to the main body.

9. The part according to claims 8, wherein the closure body has a disc-like geometry and the plurality of apertures are provided between each of the plurality of closure elements that come to rest at least regionally overlapping with the plurality of apertures of the main body in the open state.

10. The part according to claim 9, wherein the closure body is axially offset to at least one of an outside and axially to an inside in relation to the main body.

11. The part according to claim 9, wherein the closure body is pivotably mounted on at least one of the main body and a hub of the wheel.

12. The part according to claim 1, further comprising a plurality of flat segments pivotably mounted around pivot axes that extend in a radial direction to the axle of the wheel.
